(19) United States
(12) Patent Application Publication
(10) Pub. No.: US 2003/0168964 A1
(43) Pub. Date: Sep. 11, 2003

(54) Nanowire light emitting device and display

(76) Inventor: Hsing Chen, Ju-Bei City (TW)

Correspondence Address: PRO-TECHTOR INTERNATIONAL, 20775 Norada Court, Saratoga, CA, 95070-3018, US

(21) Appl. No.: 10/230,676

(22) Filed: Aug. 29, 2002

(30) Foreign Application Priority Data
Mar. 11, 2002 (TW) 091104649

(51) Int. Cl. H01J 1/62

(52) U.S. Cl. 313/495

(57) ABSTRACT

A nanowire light emitting device and display includes a cover substrate , and a transparent conductive substrate mounted on the transparent conductive film and having a surface plated with a metal layer, a nanowire light emitting member mounted on the transparent conductive substrate and having multiple nanowire light emitting diodes each having a structure of P-type, N-type and light emitting layer, and an insulation layer support post mounted between the transparent conductive substrate and the cover substrate for supporting the transparent conductive substrate and the cover substrate.

### BACKGROUND OF THE INVENTION

1. Field of the Invention The present invention relates to a nanowire light emitting device and display, and a method for manufacturing the nanowire light emitting device and display.

2. Description of the Related Art

A conventional nanowire in accordance with the prior art shown in FIG. 1 comprises a substrate 1, a metal catalyst 3 mounted on the substrate 1, and multiple nanowires 2 grown on the metal catalyst 3. However, the conventional nanowire light emitting device has a higher cost, and has a smaller area.

### SUMMARY OF THE INVENTION

The primary objective of the present invention is to provide a nanowire light emitting device and display that has a high efficiency.

Another objective of the present invention is to provide a nanowire light emitting device and display, wherein the nanowire LED has a long lifetime and has a high light emitting efficiency (at least 20 luminance).

A further objective of the present invention is to provide a nanowire light emitting device and display, wherein the nanowire LED may save the energy and use a lower voltage.

A further objective of the present invention is to provide a nanowire light emitting device and display, wherein the nanowire LED is safe and has an environmental protection effect.

A further objective of the present invention is to provide a nanowire light emitting device and display, wherein the nanowire LED has a rapid velocity, has a larger viewing angle, and has a very small thickness.

In accordance with one aspect of the present invention, there is provided a nanowire light emitting device and display, comprising:

a transparent conductive substrate;

a cover substrate mounted on the transparent conductive substrate and having a surface plated with a metal layer;

a nanowire light emitting member mounted on the transparent substrate, and including multiple nanowire light emitting diodes each having a structure of P-type, N-type and light emitting layer;

an insulation layer support post mounted between the transparent conductive substrate and the cover substrate for supporting the transparent conductive substrate and the cover substrate; wherein,

the transparent conductive substrate overlaps the cover substrate, the insulation layer support post supports the transparent conductive substrate and the cover substrate, the nanowire light emitting member is mounted in the insulation layer support post, the metal layer on the cover substrate and the transparent conductive substrate serve as electrode conductors, and the nanowire light emitting member emits light that is emitted outward from the transparent conductive substrate.

Preferably, the transparent conductive substrate is made of material selected from the group of: ZnO, GaN and SiC, or the transparent conductive substrate is made of a transparent substrate plated with transparent conductive film such as ITO, ZnO or diamond. Preferably, the nanowire light emitting member is made of a semi-conductor light emitting material selected from the group of: GaN, ZnSe, GaAs, ZnO and Si.

Preferably, each of the nanowire light emitting diodes may be grown on the transparent conductive substrate or the cover substrate.

Preferably, the insulation layer support post may be made on the transparent conductive substrate or the cover substrate.

Preferably, the insulation layer support post may be made of SiO₂ or heat-proof light resistance material.

Preferably, the thickness of the insulation layer support post is about 3to 10 μm.

In accordance with another aspect of the present invention, there is provided a method for manufacturing a nanowire light emitting device and display, comprising the steps of:

plating an insulation layer on a transparent conductive substrate, mounting a light resistance layer on a surface of the insulation layer,

forming an exposure and development zone in the light resistance layer,

removing the insulation layer in the exposure and development zone by etching, so that each of two sides of the transparent conductive substrate is formed with an insulation layer support post;

plating a metal catalyst on the transparent substrate, removing the light resistance layer, placing the transparent conductive substrate into a reaction cavity to grow multiple nanowires by a VLS (vapor phase-liquid phase-solid phase) method, adding different components during growth of the nanowires, thereby forming nanowires with a P-N semi-conductor interface;

mounting a cover substrate on the transparent conductive substrate, plating an eutectic alloy material on the cover substrate on the metal catalyst on a top of the nanowires; and

pre-providing each of the cover substrate and the transparent conductive substrate with connecting terminals, heating the cover substrate, so that the eutectic alloy material on the cover substrate may be bonded on the metal catalyst on the top of the nanowires, and coating a bonding glue a connection of the cover substrate and the transparent conductive substrate.

Preferably, the nanowires includes nanowire light emitting diodes which form a light emitting block, and a single light emitting block or multiple light emitting blocks forms or form a planar light source or a planar display.

Preferably, the nanowire light emitting diodes may emit blue rays (430 to 470 nm), violet rays (395 to 420 nm) or ultraviolet rays (350 to 395 nm).

Preferably, when the nanowire light emitting diodes emit blue rays (430 to 470 nm), the light emitting surface may be coated with yellow fluorescent material (YAG) to produce two-wavelength white rays, or coated with red and green fluorescent material to produce three-wavelength white rays.

Preferably, when the nanowire light emitting diodes emit blue rays, the light emitting surface may be coated with green or red fluorescent material, so that the places coated with green fluorescent material may produce green rays, the places coated with red fluorescent material may produce red rays, and the places not coated with green or red fluorescent material may produce blue rays, thereby forming a full color display with red, blue and green colors.

Preferably, when the nanowire light emitting diodes emit violet rays (395 to 420 nm), the light emitting surface may be coated with red, blue or green fluorescent material, so as to produce red, blue or green rays, thereby forming a full color display with red, blue and green colors, or the light emitting surface may be coated with mixed red, blue and green fluorescent material, so as to produce white rays.

Preferably, when the nanowire light emitting diodes emit violet rays (395 to 420 nm), the red fluorescent material is 3.5MgO.0.5MgF₂.GeO₂: Mn or 6MgO.AS₂O₅: Mn, the blue fluorescent material is ZnS: Cu, Al or Ca₂MgSi₂O₇Cl, and the green fluorescent material is BaMgAl₁₀O₁₇: Eu or (Sr, Ca, Ba Mg)₁₀ (PO₄)₆Cl₂: Eu.

Preferably, when the nanowire light emitting diodes emit ultraviolet rays (350 to 395 nm), the light emitting surface may be coated with red, blue or green fluorescent material, so as to produce red, blue or green rays, thereby forming a full color display with red, blue and green colors, or the light emitting surface may be coated with mixed red, blue and green fluorescent material, so as to produce white rays.

Preferably, when the nanowire light emitting diodes emit ultraviolet rays, the red fluorescent material is Y₂O₂S₂: Eu, the blue fluorescent material is BaMgAl₁₀O₁₇: Eu or (Sr, Ca, Ba, Mg)₁₀ (PO₄)₆Cl₂: Eu, and the green fluorescent material is BaMgAl₁₀O₁₇: Eu, Mn.

Preferably, the insulation layer is made on the cover substrate, and the cover substrate is then mounted on the transparent conductive substrate.

Preferably, the transparent conductive substrate is plated with a metal catalyst having a thickness of about 50 to 500 Å.

Preferably, the metal catalyst is Au, and has an eutectic made of Sn, Sb, Pb, Si. Ge or Bi.

Preferably, the nanowire light emitting diodes may be grown on the transparent conductive substrate or the cover substrate.

Further benefits and advantages of the present invention will become apparent after a careful reading of the detailed description with appropriate reference to the accompanying drawings.

### BRIEF DESCRIPTION OF THE DRAWINGS

FIG. 1 is a cross-sectional view of a conventional nanowire light emitting device in accordance with the prior art;

FIG. 2 is a cross-sectional view of a part of the nanowire and display in accordance with the first embodiment of the present invention;

FIG. 3 is a cross-sectional view of a part of the nanowire light emitting device and display in accordance with the first embodiment of the present invention;

FIG. 4 is a cross-sectional view of a part of the nanowire light emitting device and display in accordance with the first embodiment of the present invention;

FIG. 5 is a cross-sectional view of a part of the nanowire light emitting device and display in accordance with the first embodiment of the present invention;

FIG. 6 is a cross-sectional view of a part of the nanowire light emitting device and display in accordance with the first embodiment of the present invention;

FIG. 7 is a cross-sectional view of a part of the nanowire light emitting device and display in accordance with the first embodiment of the present invention;

FIG. 8 is a cross-sectional view of a part of the nanowire light emitting device and display in accordance with the first embodiment of the present invention;

FIG. 9 is a cross-sectional view of the nanowire light emitting device and display in accordance with the first embodiment of the present invention;

FIG. 10 is a cross-sectional view of a part of the nanowire light emitting device and display in accordance with the first embodiment of the present invention;

FIG. 11 is a cross-sectional view of a part of the nanowire light emitting device and display in accordance with the second embodiment of the present invention;

FIG. 12 is a cross-sectional view of a part of the nanowire light emitting device and display in accordance with the second embodiment of the present invention;

FIG. 13 is a cross-sectional view of a part of the nanowire light emitting device and display in accordance with the second embodiment of the present invention;

FIG. 14 is a cross-sectional view of a part of the nanowire light emitting device and display in accordance with the second embodiment of the present invention;

FIG. 15 is a cross-sectional view of a part of the nanowire light emitting device and display in accordance with the second embodiment of the present invention;

FIG. 16 is a cross-sectional view of the nanowire light emitting device and display in accordance with the second embodiment of the present invention;

FIG. 17 is a cross-sectional view of the nanowire light emitting device and display added with fluorescent powder; and

FIG. 18 is a cross-sectional view of the nanowire light emitting device and display added with three-color fluorescent powder.

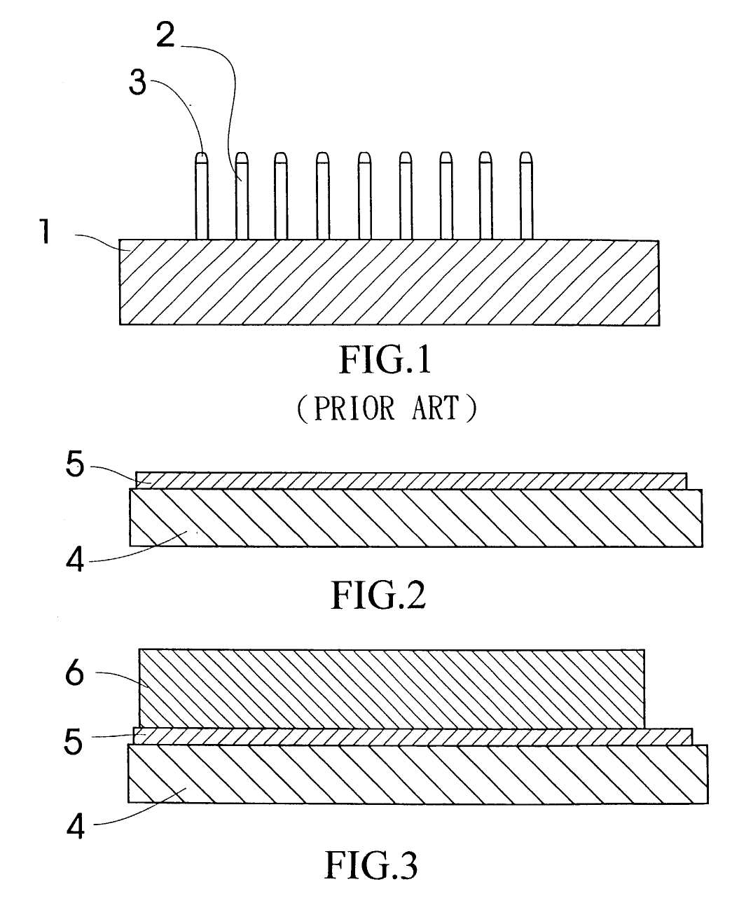

### DETAILED DESCRIPTION OF THE INVENTION

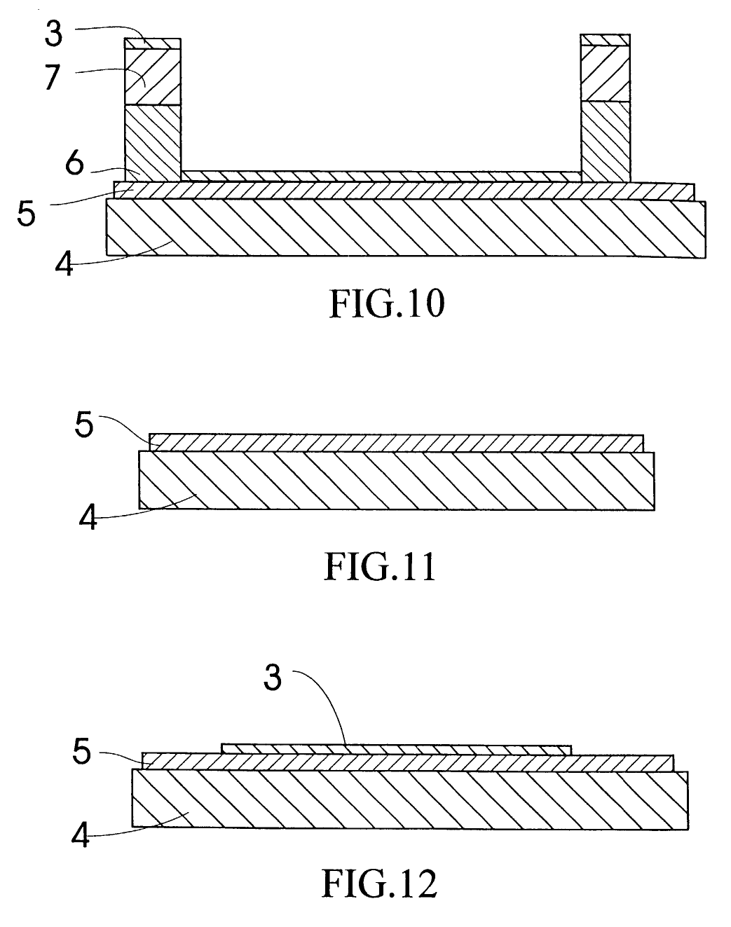

Referring to the drawings and initially to FIGS. 2-10, a method for making a nanowire light emitting device and display in accordance with a first embodiment of the present invention comprises the following steps.

First of all, a transparent substrate 4 plated with a transparent conductive layer 5 (ITO, ZnO or diamond) as shown in FIG. 2 is plated with an insulation layer 6 (SiO₂) as shown in FIG. 3. The thickness of the insulation layer 6 is about 3 to 10 μm.

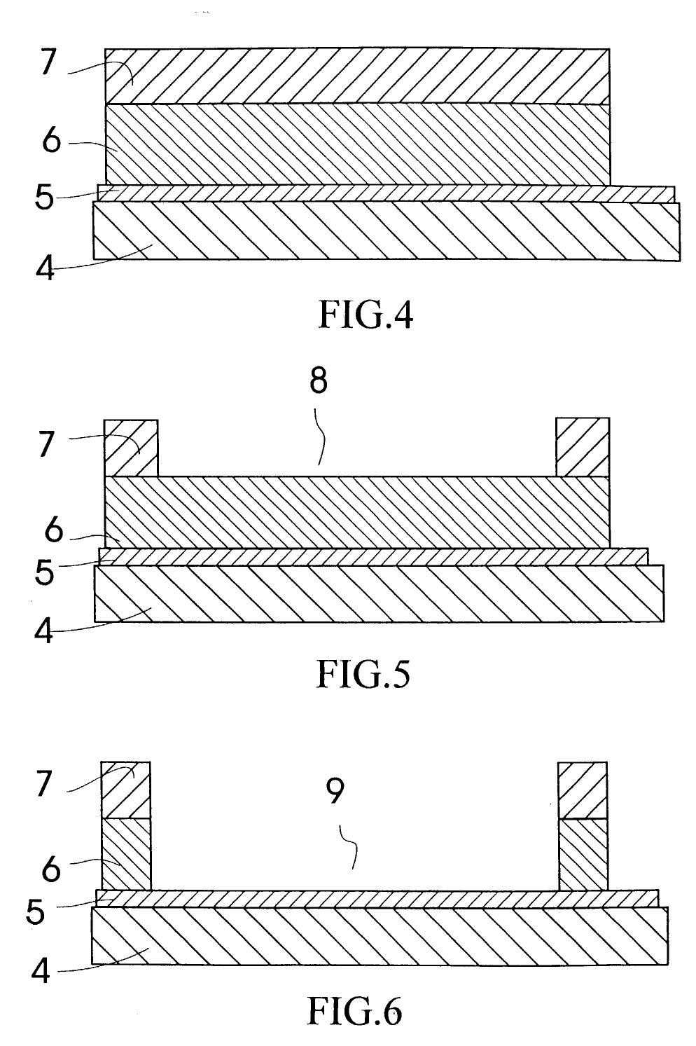

Then, a light resistance layer 7 is mounted on the surface of the insulation layer 6 as shown in FIG. 4.

Then, an exposure and development zone 8 is formed in the light resistance layer 7 as shown in FIG. 5, and the insulation layer 6 in the exposure and development zone 8 may be removed by etching as shown in FIG. 6, thereby forming an etching zone 9.

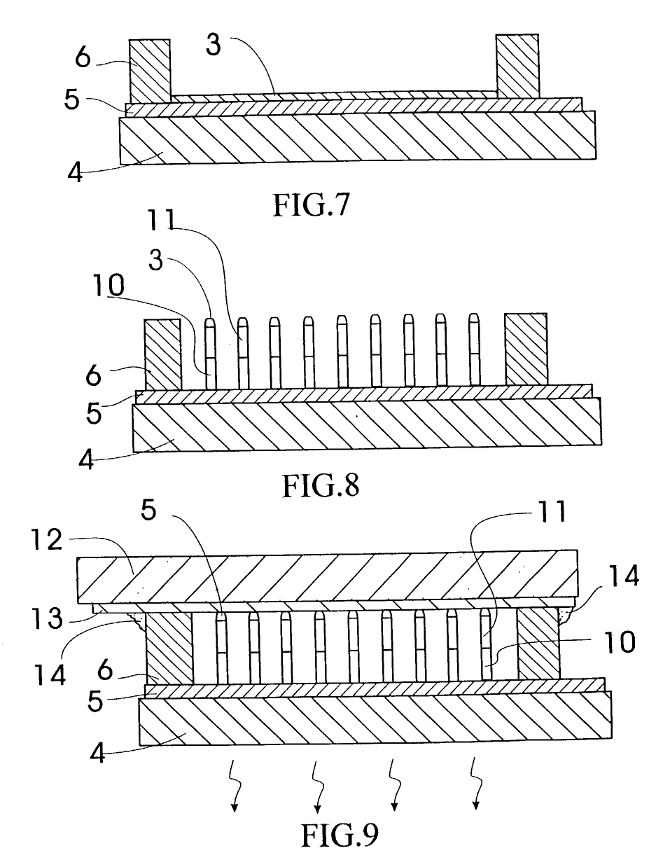

Then, the transparent substrate 4 is plated with a metal catalyst 3 (Au) having a thickness of about 50 to 500 Å as shown in FIG. 7, and is heated (about 650° C.), so that the metal catalyst 3 of the gold may form a nano gold point.

Then, after the light resistance layer 7 is removed as shown in FIG. 8, the transparent substrate 4 is sent to a furnace to grow the nanowire by the VLS method, and different components are added during growth of the nanowire, so that the nanowire may form a N-type semiconductor nanowire 10 and a P-type semiconductor nanowire 11, thereby forming the P-N interface light emitting diode structure as shown in FIG. 8.

Then, as shown in FIG. 9, a cover substrate 12 is mounted on the transparent substrate 4 having the growing nanowires, and each of the cover substrate 12 and the transparent substrate 4 is pre-provided with connecting terminals. The cover substrate 12 may be heated, so that the inner face of the cover substrate 12 is plated with an eutectic alloy material 13 (Sn, Sb or Pb) that is bonded on the metal catalyst 3 on the top of the nanowires.

Then, a bonding glue 14 may be coated on the connection of the cover substrate 12 and the transparent substrate 4, thereby preventing water from infiltrating into the elements.

Then, the power is turned on, so that the light may be emitted from the surface of the transparent substrate 4.

First of all, a transparent substrate 4 is plated with a transparent conductive layer 5 (ITO, ZnO or diamond like) as shown in FIG. 11.

Then, a metal catalyst 3 having a thickness of about 50 to 500 Å is plated on the transparent substrate 4. The metal catalyst 3 may be etched in an exposure and development manner as shown in FIG. 12.

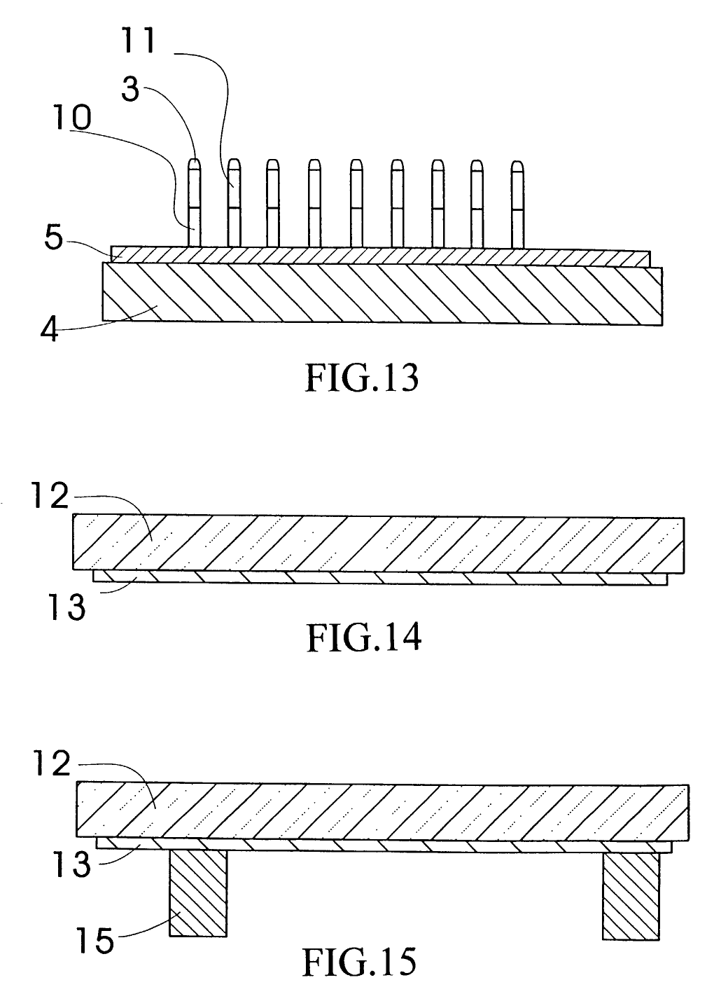

Then, the transparent substrate 4 is sent to a furnace to grow the nanowire, so as to form a N-type semiconductor nanowire 10 and a P-type semiconductor nanowire 11, thereby forming the P-N interface light emitting diode structure as shown in FIG. 13.

Then, as shown in FIG. 14, the inner face of the cover substrate 12 is plated with an eutectic alloy material 13 (Sn, Sb or Pb) that is formed by the cover substrate 12 and the metal catalyst 3.

Then, a heat-proof light resistant layer 15 is mounted on the eutectic alloy material 13 as shown in FIG. 15, and is processed by an exposure and development method to remove the residual heat-proof light resistant layer 15, so that the remaining heat-proof light resistant layer 15 may be heated and fixed to form a support function as shown in FIG. 15.

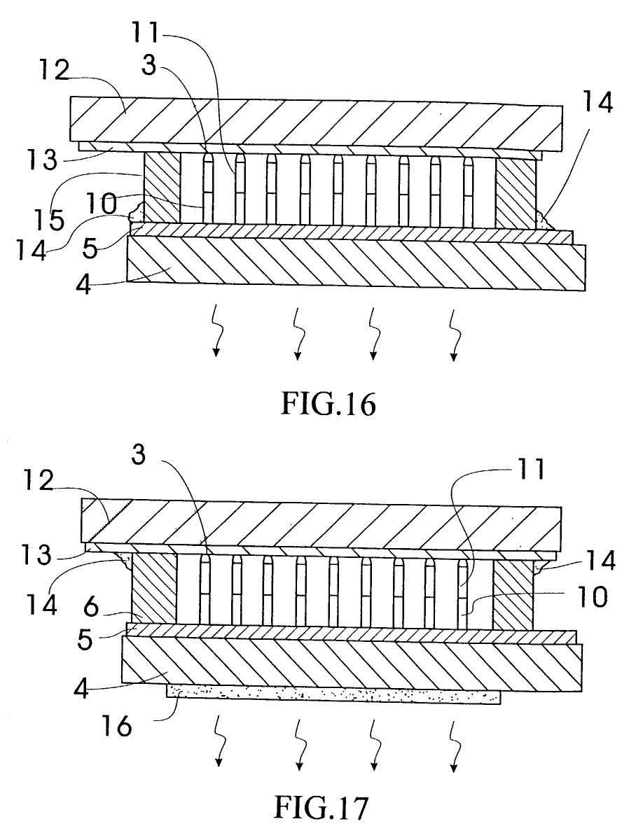

Then, the heat-proof light resistant layer 15 as shown in FIG. 15 may be mounted on the P-N interface light emitting diode structure as shown in FIG. 13, so that the cover substrate 12 may cover the transparent substrate 4 as shown in FIG. 16. The cover substrate 12 may be heated, so that the eutectic alloy material 13 is bonded on the metal catalyst 3 on the top of the nanowires.

Then, a bonding glue 14 may be coated on the connection of the cover substrate 12 and the transparent substrate 4, thereby preventing water from infiltrating into the elements.

Then, a bonding glue 14 may be coated on the connection of the cover substrate 12 and the transparent substrate 4, thereby preventing water from infiltrating into the elements.

Then, the power is turned on, so that the light may be emitted from the surface of the transparent substrate 4.

The difference between the structure of the first embodiment and that of the second embodiment is in that the support post material is different.

In the first embodiment, the inorganic SiO₂ functions as the insulation layer 6. In the second embodiment, the heat-proof light resistant layer 15 is adopted, and may be endure the temperature of 280° C. during ten minutes.

If the nanowire light emitting device uses the ultra-violet rays, the nanowire light emitting device has to use the structure of the first embodiment, so that the elements will not produce fission due to projection of the UV rays. If the nanowire light emitting device uses the blue light, and the nanowire eutectic bonding has a lower temperature, the nanowire light emitting device may use the structure of the second embodiment, to save the cost.

It is noted that, the blue light nanowire LED panel may be added with yellow fluorescent powder (YAG: Ce), so that the yellow and blue colors may form a complimentary effect, thereby forming the white light.

In addition, as shown in FIG. 17, the nanowire light emitting diode (LED) may use the ultra-violet rays (350 to 395 nm), and the nanowire LED panel may be coated with fluorescent powder 16 mixed with the red, blue and green colors, thereby forming the white light.

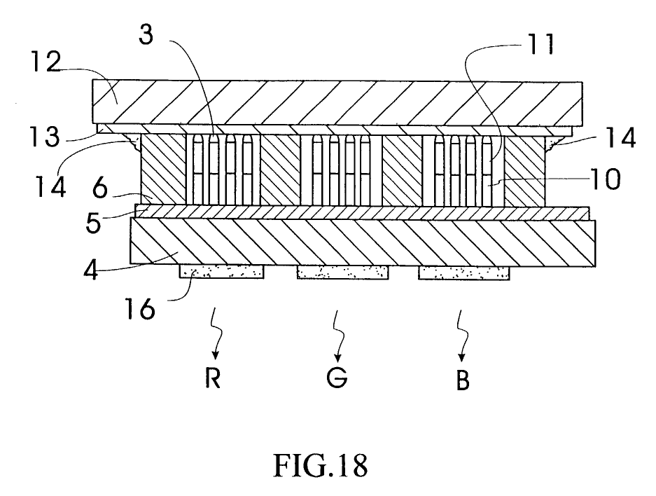

As shown in FIG. 18, all of the light emitting points are coated with fluorescent powder mixed with the red, blue and green colors, thereby forming a full color display which is the first full color inorganic nanowire light emitting diode display in the world, which has a rapid velocity, may be driven s by a lower voltage, and has a very small thickness.

Accordingly, the nanowire light emitting device and display in accordance with the present invention has a high efficiency. For example, the LED single body may make a planar display, and may make a planar white light source. The nanowire LED is an inorganic material, has a long lifetime, has a high light emitting efficiency (at least 20 luminance), may save the energy, has an environmental protection effect, may use a lower voltage, is safe, has a rapid velocity, has a larger viewing angle, and has a very small thickness.

Although the invention has been explained in relation to its preferred embodiment as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A nanowire light emitting device and display, comprising:
a transparent conductive substrate;
a cover substrate mounted on the transparent conductive substrate and having a surface plated with a metal layer;
a nanowire light emitting member mounted on the transparent substrate, and including multiple nanowire light emitting diodes each having a structure of P-type, N-type and light emitting layer;
an insulation layer support post mounted between the transparent conductive substrate and the cover substrate for supporting the transparent conductive substrate and the cover substrate; wherein,
the transparent conductive substrate overlaps the cover substrate, the insulation layer support post supports the transparent conductive substrate and the cover substrate, the nanowire light emitting member is mounted in the insulation layer support post, the metal layer on the cover substrate and the transparent conductive substrate serve as electrode conductors, and the nanowire light emitting member emits light that is emitted outward from the transparent conductive substrate.

2. The nanowire light emitting device and display in accordance with claim 1, wherein the transparent conductive substrate is made of material selected from the group of: ZnO, GaN and SiC, or the transparent conductive substrate is made of a transparent substrate plated with transparent conductive film such as ITO, ZnO or diamond.

3. The nanowire light emitting device and display in accordance with claim 1 , wherein the nanowire light emitting member is made of a semi-conductor light emitting material selected from the group of: GaN, ZnSe, GaAs, ZnO and Si.

4. The nanowire light emitting device and display in accordance with claim 1, wherein each of the nanowire light emitting diodes may be grown on the transparent conductive substrate or the cover substrate.

5. The nanowire light emitting device and display in accordance with claim 1, wherein the insulation layer support post may be made on the transparent conductive substrate or the cover substrate.

6. The nanowire light emitting device and display in accordance with claim 1, wherein the insulation layer support post may be made of SiO₂ or heat-proof light resistance material.

7. The nanowire light emitting device and display in accordance with claim 1, wherein the thickness of the insulation layer support post is about 3 to 10 μm.

8. A method for manufacturing a nanowire light emitting device and display, comprising the steps of:
plating an insulation layer on a transparent conductive substrate, mounting a light resistance layer on a surface of the insulation layer,
forming an exposure and development zone in the light resistance layer,
removing the insulation layer in the exposure and development zone by etching, so that each of two sides of the transparent conductive substrate is formed with an insulation layer support post;
plating a metal catalyst on the transparent substrate, removing the light resistance layer, placing the transparent conductive substrate into a reaction cavity to grow multiple nanowires by a VLS (vapor phase-liquid phase-solid phase) method, adding different components during growth of the nanowires, thereby forming nanowires with a P-N semi-conductor interface;
mounting a cover substrate on the transparent conductive substrate, plating an eutectic alloy material on the cover substrate on the metal catalyst on a top of the nanowires; and
pre-providing each of the cover substrate and the transparent conductive substrate with connecting terminals, heating the cover substrate, so that the eutectic alloy material on the cover substrate may be bonded on the metal catalyst on the top of the nanowires, and coating a bonding glue a connection of the cover substrate and the transparent conductive substrate.

9. The method for manufacturing a nanowire light emitting device and display in accordance with claim 8, wherein the nanowires includes nanowire light emitting diodes which form a light emitting block, and a single light emitting block or multiple light emitting blocks forms or form a planar light source or a planar display.

10. The method for manufacturing a nanowire light emitting device and display in accordance with claim 9, wherein the nanowire light emitting diodes may emit blue rays (430 to 470 nm), violet rays (395 to 420 nm) or ultraviolet rays (350 to 395 nm).

11. The method for manufacturing a nanowire light emitting device and display in accordance with claim 10, wherein when the nanowire light emitting diodes emit blue rays (430 to 470 nm), the light emitting surface may be coated with yellow fluorescent material (YAG) to produce two-wavelength white rays, or coated with red and green fluorescent material to produce three-wavelength white rays.

12. The method for manufacturing a nanowire light emitting device and display in accordance with claim 11, wherein when the nanowire light emitting diodes emit blue rays, the light emitting surface may be coated with green or red fluorescent material, so that the places coated with green fluorescent material may produce green rays, the places coated with red fluorescent material may produce red rays, and the places not coated with green or red fluorescent material may produce blue rays, thereby forming a full color display with red, blue and green colors.

13. The method for manufacturing a nanowire light emitting device and display in accordance with claim 10, wherein when the nanowire light emitting diodes emit violet rays (395 to 420 nm), the light emitting surface may be coated with red, blue or green fluorescent material, so as to produce red, blue or green rays, thereby forming a full color display with red, blue and green colors, or the light emitting surface may be coated with mixed red, blue and green fluorescent material, so as to produce white rays.

14. The method for manufacturing a nanowire light emitting device and display in accordance with claim 10, wherein when the nanowire light emitting diodes emit violet rays (395 to 420 nm), the red fluorescent material is 3.5MgO.0.5MgF₂.GeO₂: Mn or 6MgO.AS₂O₅: Mn, the blue fluorescent material is ZnS: Cu, Al or Ca₂MgSi₂O₇Cl, and the green fluorescent material is BaMgAl₁₀O₁₇: Eu or (Sr, Ca, Ba Mg)₁₀ (PO₄)₆Cl₂: Eu.

15. The method for manufacturing a nanowire light emitting device and display in accordance with claim 10, wherein when the nanowire light emitting diodes emit ultraviolet rays (350 to 395 nm), the light emitting surface may be coated with red, blue or green fluorescent material, so as to produce red, blue or green rays, thereby forming a full color display with red, blue and green colors, or the light emitting surface may be coated with mixed red, blue and green fluorescent material, so as to produce white rays.

16. The method for manufacturing a nanowire light emitting device and display in accordance with claim 10, wherein when the nanowire light emitting diodes emit ultraviolet rays, the red fluorescent material is Y₂O₂S₂: Eu, the blue fluorescent material is BaMgAl₁₀O₁₇: Eu or (Sr, Ca, Ba, Mg)₁₀ (PO₄)₆CL₂: Eu, and the green fluorescent material is BaMgAl₁₀O₁₇: Eu, Mn.

17. The method for manufacturing a nanowire light emitting device and display in accordance with claim 8, wherein the insulation layer is made on the cover substrate, and the cover substrate is then mounted on the transparent conductive substrate.

18. The method for manufacturing a nanowire light emitting device and display in accordance with claim 8, wherein the transparent conductive substrate is plated with a metal catalyst having a thickness of about 50 to 500 Å.

19. The method for manufacturing a nanowire light emitting device and display in accordance with claim 18, wherein the metal catalyst is Au, and has an eutectic made of Sn, Sb, Pb, Si. Ge or Bi.

20. The method for manufacturing a nanowire light emitting device and display in accordance with claim 9, wherein the nanowire light emitting diodes may be grown on the transparent conductive substrate or the cover substrate.
